(19) United States
(12) Patent Application Publication
(10) Pub. No.: US 2004/0065211 A1
(43) Pub. Date: Apr. 8, 2004

(54) Cooking/stirring appliance

(75) Inventor: John Duncan McNair, Olinda (AU)

Correspondence Address: LEYDIG VOIT & MAYER, LTD, 700 THIRTEENTH ST. NW, SUITE 300, WASHINGTON, DC, 20005-3960, US

(73) Assignee: Chiaphua Industries Limited, Tai Po (HK)

(21) Appl. No.: 10/265,167

(22) Filed: Oct. 7, 2002

(51) Int. Cl. A23L 1/00

(52) U.S. Cl. 99/348

(57) ABSTRACT

A cooking/stirring appliance includes a reservoir to receive liquid to be heated, a heater associated with the reservoir to heat the liquid, a vessel for receiving food to be stirred and cooked, and a drive motor and stirring blade. The appliance is particularly suitable for sauces and soups that tend to burn using conventional cooking/stirring means.

### BACKGROUND OF THE INVENTION

The present invention relates to cooking/stirring appliances. More particularly, although not exclusively, the invention relates to a sauce making appliance that can be left unattended to cook and stir a sauce and keep the sauce hot without burning it.

The usual method of cooking/stirring sauce is to combine liquid with other dry or solid components in a pan and stir with a hand held-held implement while the pan is positioned over a flame or upon an element until the desired consistency and temperature is achieved.

Sometimes stirring will be suspended while the cook attends to other tasks and even in the shortest of periods away, the sauce can become burnt and unpalatable.

### OBJECTS OF THE INVENTION

It is an object of the present invention to provide an appliance, which automates stirring and prevents the mixture from burning even when unattended for a prolonged period of time.

It is a further object of the present invention to provide an improved food-processing appliance.

It is a further complimentary object of the present invention to minimise user controls in a food-processing appliance

### DISCLOSURE OF THE INVENTION

There is disclosed herein a cooking/stirring appliance comprising:

a base including a reservoir to receive water and a heater to heat the reservoir and any water therein to produce steam,

a vessel for containing sauce or other flowable food, supported above the base to receive heat from the steam,

a stirring blade mounted within the vessel and movable with respect thereto, and

drive means causing relative movement between the stirring blade and the vessel.

Preferably the drive means comprises a motor situated in the base.

Preferably the reservoir includes a central, vertically oriented tube through which a vertical drive shaft extends to transmit output from the motor to the stirring blade.

Preferably the base and vessel are circular when viewed from above.

Preferably, the heater has associated with it a thermostatic switch to deactivate the heater upon overheating as would occur, should all the water from the reservoir be depleted.

Preferably the steam switch is positioned beneath the reservoir and the reservoir includes a longitudinal steam tube extending from a position above a maximum liquid level in the reservoir to a position adjacent to the steam switch.

Preferably a control circuit governs operation of the motor and/or heater.

Preferably the control circuit is pre-programmed.

Preferably the vessel is lidded.

Preferably there is a free-rotating blade positioned above the stirring blade within the vessel.

Preferably the stirring blade is sized and shaped to extend to a position almost immediately adjacent to a floor of the vessel.

Preferably the stirring blade is sized and shaped to extend to a position almost immediately adjacent a lower portion of a wall of the vessel.

Preferably the free-rotating blade is sized and shaped to extend to a position almost immediately adjacent to the wall of the vessel.

Preferably the vessel includes an internal abutment wall against which the free-rotating blade can abut to limit rotation thereof relative to the vessel.

Preferably the stirring blade has a substantially triangular cross section that is widest at its bottom.

Preferably the appliance further comprises reversing means for sensing an overload on the stirring blade and for automatically reversing motion of the stirring blade upon sensing the overload.

Preferably the vessel is received snugly upon the base so as to seal the reservoir substantially so that steam condenses therein for re-heating by the heater.

In an alternative arrangement, the stirring blade comprises a multi-bladed paddle driven to rotate about an axis that orbits the vertically oriented tube.

In this arrangement, there is a gearbox rotatably mounted to the tube transmitting output of the motor to the multi-bladed paddle.

### BRIEF DESCRIPTION OF THE DRAWINGS

Preferred forms of the present invention will now be described by way of example with reference to the accompanying drawings, wherein:

FIG. 1 is a schematic cross-sectional elevational view of a cooking/stirring appliance,

FIG. 2 is a schematic plan view of the appliance of FIG. 1,

FIG. 3 is a schematic cross-sectional end elevation of a stirring blade as used in the appliance of FIGS. 1 and 2,

FIG. 4 is a schematic cross-sectional elevational view of an alternative cooking/stirring appliance, and

FIG. 5 is a schematic plan view of the cooking/stirring appliance of FIG. 4.

### DESCRIPTION OF THE PREFERRED EMBODIMENTS

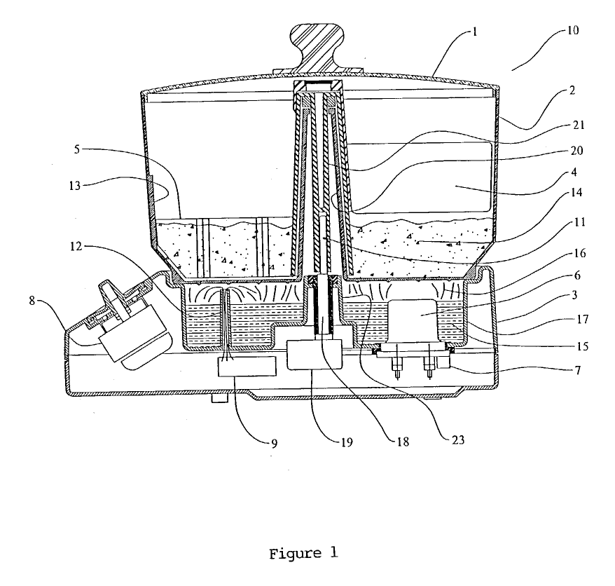

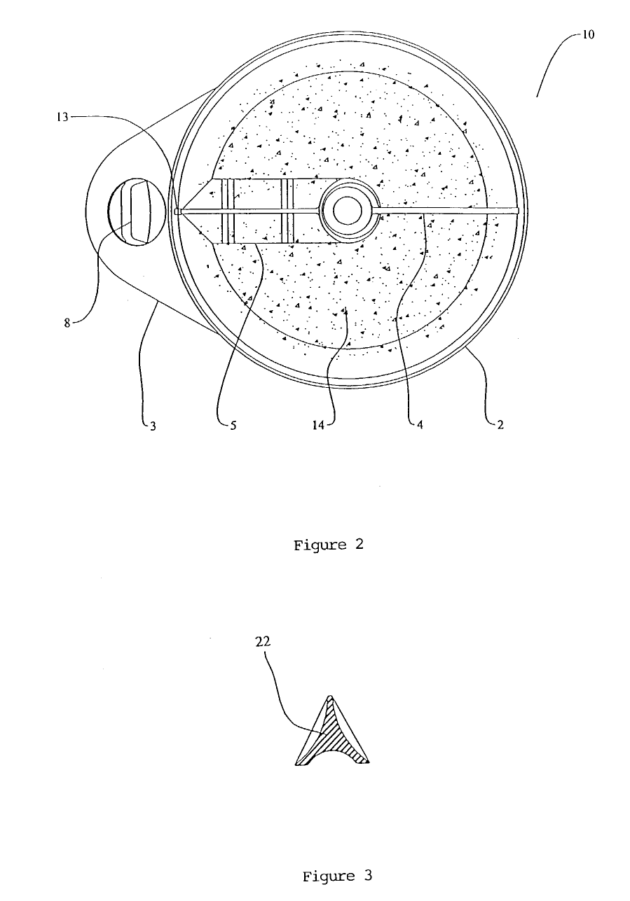

In FIGS. 1 and 2 of the accompanying drawings there is schematically depicted a cooking/stirring appliance 10. The appliance 10 includes a base 3 supporting a vessel 2. The base 3 might be formed of plastics, ceramic or metallic material for example, whereas the vessel 2 might be formed of aluminium, stainless steel or other heat-conducting waterproof material. Covering the vessel 2 is a lid 1 that would typically be formed of glass, polycarbonate or other heat resistant material that is preferably light-transmissive or transparent.

A heater 6 fixed to the reservoir 17 heats water 15 within the reservoir 17 to create steam 16.

A space alongside or under the reservoir 17 houses an electric motor 19 having an output shaft 18 that engages with a vertical drive shaft 11 and coupling arrangement which passes through the center post 23 of the reservoir 17.

The vessel 2 includes a centrally located tube 20 through which a vertical shaft 21 of a stirring blade 5 extends to engage and couple with the vertical drive shaft 11. The stirring blade 5 is typically fabricated from moulded plastic material and is sized and shaped to just clear the floor of the vessel and a short, lower portion of the vessel side wall.

A steam switch 9 is positioned beneath the reservoir 17 which includes a longitudinal steam tube 12 extending from a position above the liquid 15 in the base reservoir 17 to a position adjacent to the steam switch 9.

The steam switch 9 is associated with a control circuit positioned at 8 for example. A thermister or a thermostat might alternatively be substituted for the steam switch.

The blade 5 can have mounted above it and on the same axis, a free-rotating blade 4 that is free to rotate in either direction but would typically be provided as a unit with blade 5. That is, one blade would typically not be removable from the other. The blade 4 is sized and shaped to just clear the wall of the vessel 2. The free-rotating blade 4 is intended to flip the food over the stirring blade all five to encourage proper stirring and mixing.

Situated within the vessel 2 is a short abutment wall or stop 13 with which the free-rotating blade 4 can engage. As a result of this engagement, rotation of the free-rotating blade 4 is inhibited. If the stirring blade 5 reverses direction as a result of an overload condition, the free-rotating blade or for will reverse through one revolution and till it engages the stop 13 again. At this point, the free-rotating blade acts again as a flipper. The reason for this “dead movement” is to allow for the necessity of just a single stop 13 so that the user can position the free-rotating blade at almost any orientation, rather than having to fit the distal end of the free-rotating paddle into a slot formed on the inner surface of the receptacle for example.

A lid 1 is supplied to fit the vessel 2 to reduce heat loss, evaporation and consequent drying of the mixture 14 when the sauce making has been completed.

In use water 15 is added to the reservoir 17 by measure or to a mark shown in the reservoir. The vessel 2 is then fitted to anti-rotation locations (not shown) at the top of the reservoir 17 causing a snug fit between the two components. Water and steam in the reservoir will be recycled and therefore heating/re-heating can continue for a long period, due to the snug fit between the base 3 and the vessel 2 and the action of the steam switch 9.

The blade assembly 4 & 5 is then fitted into the vessel, whereupon the shaft 21 couples with the motor output shaft 11. Liquid and solid components (the mixture 14) are then added to the vessel 2 in accordance with a user-selected recipe. The motor 19 and heater 6 are then energised. The blade assembly 4 & 5 then rotates in the mixture 14 combining the ingredients and other ingredients as might be added to the mixture from time to time. After a period, some of the water 16 in the reservoir 17 will be turned to steam 16 condensing on the base of the vessel 2 and giving up its latent heat to heat the ingredients 14 being mixed in the vessel 2. Due to the nature of steam 16 it does not get hotter than the temperature of boiling water 15 and therefore the ingredients 14 do not burn. After condensing on the base of the vessel 2 the condensate returns to the reservoir 17 for re-heating and the cycle continues. If excess boiling occurs in the reservoir 17, there will be an excess of steam 16 that will be forced by pressure to move downward through the steam tube 12 and exit to condense on and activate the steam switch 9.

To ensure that the ingredients 14 are mixed well, the stirring blade 5 is shaped such that it has a substantially triangular cross section 22 as shown in FIG. 3 to allow the ingredients 14 to be forced upward as the blade 5 rotates and moves through the mixture 14. If the load on the blade 5 is excessive the motor 19 will automatically reverse as a result of a sensing device, or from the provision of a synchronous motor that reverses upon sensing overload. The blade 5 will also reverse direction when chunky food 14 becomes lodged on top of the blade 5 jamming against the blade 4, causing the blades 4 and 5 to move as one. Within one revolution, the blade 4 engages the short abutment wall or stop 13 on the vessel 2, causing resistance, which the motor 19 can sense to reverse the stirring action and release the jam. That is, food caught between the free-rotating blade and the stirring blade will result in the two blades being effectively fixed to one another. Abutment of the free-rotating blade with the stop 13 will therefore also stop rotation of the stirring blade to thereby overload the motor.

Possible uses of the appliance are to make sauce, soup, stews, beans, spaghetti, jams, scrambled eggs and many other dishes.

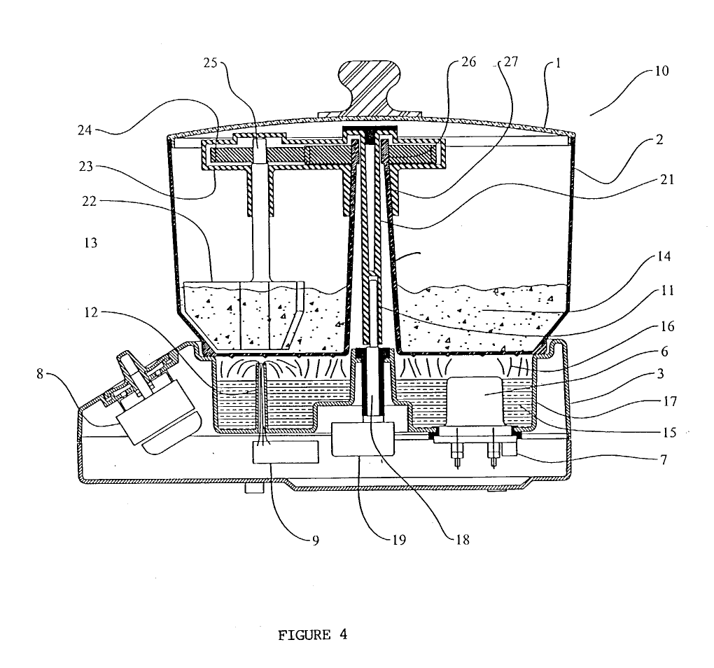

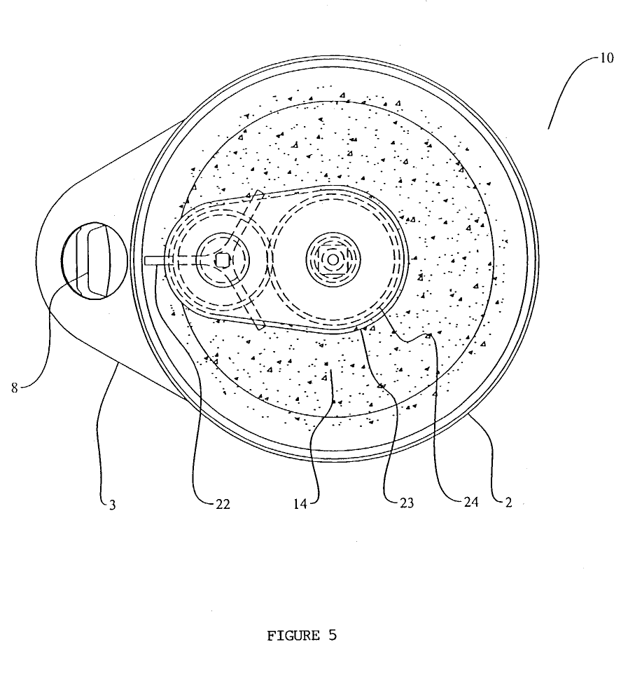

An embodiment comprising a different stirring blade arrangement is depicted in FIGS. 4 and 5. In this embodiment, there is a star-shaped mixer 21 including three radially extending stirring blades. The mixer 21 coupled at a drive coupling 25 to an outer gear within the gear casing 23 and depends from the gear casing within which a gear system 24 is located. The gear system 24 includes a mounting arrangement 26 including a bearing surface 27 by which the gear casing is rotatably mounted to the hollow cylinder 20. The gear casing 23 rotates about the hollow cylinder 20 by action of the motor output shaft 18. There is a fixed gear that engages with the shaft 21 such that rotation of the casing 23 caused by rotation of shaft 21 causes the casing to rotate about the centre axis of the cooking vessel. As other outer gear is in mesh with the inner gear, the outer gear rotates to thereby effect orbital movement of the star-shaped mixer 21 about the centre axis of the vessel 2 and rotation of the mixer 22 about its own vertical axis. Each blade of the mixer 21 includes distal edges that extend substantially to the wall of the vessel 2 and its floor. Operation of this embodiment is otherwise much the same as that of the embodiment depicted in FIGS. 1 to 3.

It should be appreciated that modifications and alternations obvious to those skilled in the art are not to be considered as beyond the scope of the present invention.

1. A cooking/stirring appliance comprising:
a base including a reservoir to receive water and a heater to heat the reservoir and any water therein to produce steam,
a vessel for containing sauce or other flowable food, supported above the base to receive heat from the steam,
a stirring blade mounted within the vessel and movable with respect thereto, and
drive means causing relative movement between the stirring blade and the vessel.

2. The appliance of claim 1 wherein the drive means comprises a motor situated in the base.

3. The appliance of claim 1 wherein the reservoir includes a central, vertically oriented tube through which a vertical drive shaft extends to transmit output from the motor to the stirring blade.

4. The appliance of claim 1 wherein the base and vessel are circular when viewed from above.

5. The appliance of claim 1 wherein the heater has associated with it a thermostatic switch to deactivate the heater upon overheating as would occur, should all the water from the reservoir be depleted.

6. The appliance of claim 5 wherein the switch is positioned beneath the reservoir and the reservoir includes a longitudinal steam tube extending from a position above a maximum liquid level in the reservoir to a position adjacent to the switch.

7. The appliance of claim 2 further comprising a control circuit governing operation of the motor and/or heater.

8. The appliance of claim 7 wherein the control circuit is pre-programmed.

9. The appliance of claim 1 wherein the vessel is lidded.

10. The appliance of claim 1 further comprising a free-rotating blade positioned above the stirring blade within the vessel.

11. The appliance of claim 1 wherein the stirring blade is sized and shaped to extend to a position almost immediately adjacent to a floor of the vessel.

12. The appliance of claim 11 wherein the stirring blade is sized and shaped to extend to a position almost immediately adjacent a lower portion of a wall of the vessel.

13. The appliance of claim 10 wherein the free-rotating blade is sized and shaped to extend to a position almost immediately adjacent to the wall of the vessel.

14. The appliance of claim 13 wherein the vessel includes an internal abutment wall against which the free-rotating blade can abut to limit rotation thereof relative to the vessel.

15. The appliance of claim 1 wherein the stirring blade has a substantially triangular cross-section that is widest at its bottom.

16. The appliance of claim 1 further comprising reversing means for sensing an overload on the stirring blade and for automatically reversing motion of the stirring blade upon sensing the overload.

17. The appliance of claim 1 wherein the vessel is received snugly upon the base so as to substantially seal the reservoir so that steam condenses therein for re-heating by the heater.

18. The appliance of claim 3 wherein the stirring blade comprises a multi-bladed paddle driven to rotate about an axis that orbits the vertically oriented tube.

19. The appliance of claim 18 further comprising a gearbox rotatably mounted to the tube and transmitting output of the motor to the multi-bladed paddle.
